(19) United States
(12) Patent Application Publication
(10) Pub. No.: US 2022/0274298 A1
(43) Pub. Date: Sep. 1, 2022

(54) FOAMED HOLLOW CHAMBER PROFILES

(71) Applicant: NMC SA, Eynatten (BE)

(72) Inventors: Silvain MEESSEN, Welkenraedt (BE); Jean-Pierre MAYERES, Eupen (BE)

(21) Appl. No.: 17/624,874

(22) PCT Filed: Jul. 13, 2020
(86) PCT No.: PCT/EP2020/069753

§ 371 Date: Jan. 5, 2022

(30) Foreign Application Priority Data
Jul. 18, 2019 (BE) 2019/5472

(51) Int. Cl. B29C 44/22; B29C 44/50; B29C 44/56; C08J 9/42; C08J 9/14; C08J 9/12; E04B 1/68

(52) U.S. Cl. CPC B29C 44/22; B29C 44/50; B29C 44/5627; C08J 9/42; C08J 9/141; C08J 9/122; E04B 1/6812; B29K 2995/0015; C08J 2201/03; C08J 2203/14; C08J 2203/06; C08J 2367/00; E06B 7/2314

(57) ABSTRACT

A method for manufacturing a foamed profile including one or more longitudinal hollow chambers having a closed section, including (a) extruding a first polymer composition, in the presence of one or more first foaming agents, into a foamed base profile having a polygonal section, preferably a rectangular section, the first polymer composition including one or more (co)polyesters, (b) cooling the foamed base profile, (c) creating a trench along the length of the foamed base profile by removing material, preferably by means of milling, cutting, laser or thermofusion, the trench forming two parallel branches in the foamed base profile, each of the branches including an outer surface opposite the trench and an inner surface facing the trench, and (d) extruding, inside the trench, a second polymer composition which may or may not be identical to the first polymer composition, preferably in the presence of one or more second foaming agents, into a spacer at at least one location between the two inner surfaces of the two branches of the trench, so as to form at least one closed hollow chamber inside the trench. The disclosure also related to foamed profiles including one or more longitudinal hollow chambers having a closed section, in particular insulators for reducing the thermal bridge effect between two connected building elements.

### TECHNICAL FIELD DISCLOSURE

The present disclosure relates in general to the field of thermal insulation and in particular to foamed profiles which comprise cavities and are particularly useful in the field of thermal bridge breaking devices in construction in relation to glazing, doors, façade elements, etc.

### BACKGROUND OF THE DISCLOSURE

Foamed profiles of a wide variety of sections are used in many fields where thermal or acoustic insulation plays an important role. For example, in the field of construction, in particular in metallic construction or in the field of manufacturing doors, windows or façade cladding in particular comprising structural elements made from compact plastic or metallic materials, it is well known that breaks in thermal bridges must be provided. This is because a thermal bridge is a punctual or linear zone which, in a building envelope, exhibits an increase in thermal conductivity. It is a point in the structure where the insulating barrier is broken, resulting not only in heat losses to the outside, but also in condensation and therefore moisture on the inside. Since buildings are increasingly airtight, air renewal is limited and the walls remain damp. This results in mould and bad odours which can result in some people developing allergies.

At present, “thermal bridge breakers” or “insulators” are commonly used for structural elements which have both an internal face and a face exposed to the outside. In practice, an entire window frame may be manufactured from a poorly thermally conductive material including PVC, or from metal, i.e. a highly thermally conductive material. The frame will usually have an internal face (or profile) and an external face (or profile) which are separated by poorly thermally conductive elements, for example insulating connectors or insulators made from synthetic material.

These insulators which serve to break/avoid thermal bridges must, however, be sufficiently rigid and robust not to be deformed or broken on insertion into the clip of the structural element and for example when a fastening screw is screwed through them. Consequently, they generally take the form of longitudinal profiles with long edges equipped with specific sections intended to be attached by snap-fastening, push fitting, interlocking, insertion, etc. into or onto sections of substantially complementary shape on one of the profiles or structural elements. They are furthermore manufactured from a robust synthetic material, in particular PVC, PP, etc. Apart from the health reasons for reducing the effects of thermal bridges, the energy performance requirements applicable to buildings are becoming increasingly stringent.

It is likewise well known also that the thermal conduction of a foamed or unfoamed profile may be further reduced by providing cavities in the perpendicular cross-section, which thus impede energy flow and so give rise to better thermal insulation.

While it is well known to form cavities of a relatively large section (e.g. greater than 10 cm²) in foamed profiles if the requirements for dimensional accuracy are not too stringent, by extrusion using one or more needles at the outlet die which are located within the stream of polymer composition to be foamed originating from the extruder, this method cannot be used to obtain cavities of smaller section, e.g. of the order of 5 cm², or even less than 2 cm². If cavities of such sizes are required, the only known solution is to manufacture the profile in two (or a plurality of) parts (partial profiles), to machine each part so as to create therein the open parts of the cavities and then to assemble them by welding or adhesive bonding to form foamed profiles comprising closed cavities.

Apart from the disadvantage of multiplying the manufacturing steps, assembling a plurality of partial profiles makes in-line production largely unworkable. In practice, such assembly in any event entails numerous handling operations and is therefore the weak link with regard to production rate and costs.

### BRIEF SUMMARY

The disclosure provides insulating foamed profiles comprising cavities (and a manufacturing method), in particular foamed profiles of small sections (e.g. less than 15 cm²) with cavities of small section (e.g. less than 2 cm²), in particular for use as an insulating element, preferably as an insulator between two structural profiles, wherein the foamed profiles exhibit sufficient mechanical strength.

In order to achieve the above, the present disclosure proposes, in a first aspect, a method for manufacturing a foamed profile comprising one or more longitudinal cavities of closed section, the method comprising the steps of
(a) extruding a first polymer composition in the presence of one or more first foaming agents to yield a foamed base profile of polygonal section, preferably of rectangular section, the first polymer composition comprising one or more (co)polyesters,
(b) cooling the foamed base profile,
(c) creating one (or more) channel(s) along the length of the foamed base profile by removing material, preferably by milling, cutting, laser or thermal fusion, etc., the (or each) channel forming two parallel branches in the foamed base profile, each of the branches comprising an outer surface facing away from said channel and an inner surface facing towards said channel, and
(d) extruding inside the channel(s) a second polymer composition, which may or may not be identical to the first polymer composition, preferably in the presence of one or more second foaming agents, to yield a cross strut at at least one location between the two inner surfaces of the two branches of the channel, so as to form at least one closed cavity within the channel.

The method according to the disclosure does not requires assembly of a plurality of partial profiles and all the steps may therefore, if desired, be carried out in-line. The inventors have moreover developed a method which makes it possible to create even very small cavities in profiles which are themselves small in size. It is clear that the above method, which enables the production even of offset cavities in parallel channels, is very flexible and applicable in numerous settings, even for larger section profiles, in which the multiple channels could even not be parallel, but instead made on different sides of the polygonal section of the foamed base profile. The machining of step (c) is moreover facilitated by the use of a first polymer composition based on (co)polyester(s) which give rise to foams having relatively high mechanical strength.

It is often necessary to provide the outside of the foamed profile with a particular shape or contour. This may be achieved on the one hand by removing material or on the other hand by adding material.

An advantageous variant of the method provides working the external contour of the profile by removing material, for example by providing, after step (b), a step (c′) of creating an external contour element on at least one of the sides of the foamed base profile by removing material, preferably by milling, cutting, laser, thermal fusion, etc., step (c′) preferably being performed simultaneously with step (c).

An advantageous variant of the method provides working the external contour of the profile by adding material, for example by further providing a step (x) of extruding a third polymer composition, preferably in the presence of one or more third foaming agents to yield a number of fins on one or more sides of the base profile, wherein step (x) may be carried out during step (a) by coextrusion or by separate extrusion after one of the subsequent steps, preferably before, during or after step (d). Depending on the application, these fins may in particular act as supporting elements, as means for compartmenting the adjacent space when the tip of the ribs is at a distance of 0 to 2 mm from the adjacent structural element in order to reduce convection in this space, or alternatively as water drainage grooves.

Other particularly advantageous variants provide modifying the external contour both by removal and addition of material depending on the location on the contour of the foamed base profile.

As already mentioned above, (co)polyesters make it possible to impart a certain mechanical strength to the profiles, this strength being advantageous both in the finished product and during material removal machining steps. The first polymer composition consequently preferably comprises at least one polyester or copolyester selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, particularly preferably the polyester comprises or is composed of polyethylene terephthalate. Generally, the first polymer composition may comprise other compatible polymers, for example thermoplastic elastomers (TPE), such as thermoplastic polyester elastomers (TPC), unvulcanized thermoplastic olefinic elastomers (TPO), thermoplastic urethane elastomers (TPU), thermoplastic styrenic elastomers (TPS), thermoplastic polyamide elastomers (TPA), ethylene copolymers, such as ethylene-vinyl acetate copolymers (EVA), ethylene-methyl acrylate copolymers (EMA), ethylene-ethyl acrylate copolymers (EEA), ethylene-butyl acrylate copolymers (EBA), etc., modified or unmodified by groups such as maleic anhydride or alternatively glycidyl methacrylate to compatibilize them, polycarbonate, polystyrene, polyamide, etc., but generally the content of polyester(s) in the first polymer composition is greater than 60% by weight, preferably greater than 75% by weight, particularly preferably greater than 80% by weight, relative to the total quantity of polymers in the first polymer composition.

The cross struts are produced using a second polymer composition, the (co)polymers of which are identical to or different from those of the first polymer composition. In simplified manner, suitable component(s) of the second polymer composition, are the above-mentioned (co)polyesters, together with any polymer compatible with the (co)polyesters used in the first polymer composition, in particular thermoplastic elastomers (in particular TPC, TPA, TPO, TPU, etc.), ethylene copolymers (in particular EVA, EMA, EBA, EEA, etc.), modified or unmodified by groups such as maleic anhydride or alternatively glycidyl methacrylate to compatibilize them, polycarbonate, polystyrene, polyamide, etc. The inventors have, however, found that particularly advantageous polymers for the second polymer composition are preferably selected from thermoplastic elastomers, preferably TPU and blends of TPU with other ethylene copolymers. Using these polymer compositions, it is possible reliably to form cross struts which are attached to both sides of the channel and are of relatively slender thickness (for example of the order of one to several mm, or even less), i.e. reliably to form closed cavities, even small in size. This is because these compositions may be extruded through fine dies which enter the channel, each die forming a cross strut at a different depth of the channel, so giving rise to a series of longitudinal cavities parallel to the length of the base profile.

For the above-mentioned external contours by adding material, the third polymer composition may comprise the (co)polymers mentioned for the first and second polymer compositions and preferably comprises at least one (co)polymer selected from thermoplastic elastomers (in particular TPC, TPA, TPO, TPU, etc.), ethylene copolymers (in particular EVA, EMA, EBA, EEA, etc.), modified or unmodified by groups such as maleic anhydride or alternatively glycidyl methacrylate to compatibilize them, polystyrene, polyamide, etc.

All the compositions polymers described here may be foamed (the first being mandatorily foamed). The first, second and third foaming agents usable in the context of the method may be physical or chemical foaming agents or a combination of these two types. Chemical blowing agents (CBA) are foaming agents which decompose under the effect of an increase in temperature. They are divided into two families: exothermic CBAs, such as azodicarbonamide (ADCA), oxydibenzenesulfonyl hydrazide (OBSH), etc. which break down and, in so doing, produce heat. Azodicarbonamide decomposes at around 210° C., but in the presence of appropriate decomposition accelerators, such as zinc oxide and/or zinc stearate, the decomposition temperature may be reduced by approximately 60° C. Endothermic CBAs decompose and, in so doing, absorb heat. For example, citric acid, sodium hydrogen carbonate and mixtures thereof decompose at between 150 and 230° C. and generally produce a lower volume of gas per gram of CBA than do exothermic CBAs. Physical foaming agents such a molecular nitrogen, carbon dioxide, linear or branched C1 to C4 alkanes, are in gaseous form under standard temperature and pressure conditions (0° C., 1 atmosphere); while pentanes (isopentane, neopentane, normal-pentane, cyclopentane), hexane, heptane are liquid under standard conditions. These gases or liquids are soluble in the molten polymer at elevated temperature and under high pressure and form a single phase under suitable pressure and temperature conditions. By depressurising the monophasic system, nucleation and growth of the gas bubbles which have become insoluble generate a cellular structure. The foaming agent(s) is/are preferably selected from isobutane, cyclopentane and/or carbon dioxide.

Appropriate foam densities of the various (first and optionally second and/or third) polymer compositions are generally within a range between 30 kg/m³ and 800 kg/m³, preferably between 50 and 500 kg/m³ and particularly preferably between 60 and 350 kg/m³.

Other additives may generally be used independently in the three polymer compositions, such as nucleating additives (talcum, calcium stearate, silica) which facilitate nucleation of the foam bubbles and permit control of the distribution thereof, or alternatively chemical agents used for accelerating the decomposition of the chemical foaming agents (see above), fire-retardant agents, UV-stabilizers, antioxidants, crystallization nucleating agents, branching agents, lubricants, etc.

In one particularly preferred aspect of the disclosure, the method is carried out to obtain insulators for reducing the thermal effect as described above, i.e. in the method defined above, in which the foamed profile comprising one or more longitudinal cavities of closed section obtained at the end of the method is a thermal insulator for reducing thermal bridging between two connected structural elements, the method generally comprising a step (c′) in which the external contour element on one of the sides of the foamed base profile is an insulator head of narrower section than the foamed base profile arranged on the opposite side of the channel. The insulators according to the disclosure comprising a channel compartmented by cross struts have the practical advantage on the construction site of facilitating penetration of the tip of fastening screws and guidance thereof between the structural elements while they are being screwed in (see for example FIG. 2).

In another aspect, the disclosure proposes a foamed profile comprising one or more longitudinal cavities of closed section comprising a foamed base profile of polygonal section, preferably of rectangular section, the first polymer composition comprising one or more (co)polyesters, the foamed base profile comprising a channel formed by removing material, preferably by milling, cutting, laser, thermal fusion, etc., said channel being compartmented into one or more closed cavities, parallel to the length of the foamed base profile, by a number of, optionally foamed, cross struts, extruded from a second polymer composition.

As described above, the foamed profile according to the disclosure preferably further comprises a part of the external contour modified by removing material, preferably by milling, cutting, laser, thermal fusion, etc. and/or a part of the external contour modified by adding material, preferably by (co)extrusion of a number of fins or other appended structures onto one or more sides of the base profile.

Particularly preferably, the foamed profile comprising one or more longitudinal cavities of closed section is an insulator usable in construction for reducing thermal bridging between two connected structural elements, the insulator comprising an external contour element on one of the sides of the foamed base profile which is an insulator head of narrower section than the foamed base profile and which is arranged on the opposite side of the channel.

### BRIEF DESCRIPTION OF THE DRAWINGS

Other distinctive features and characteristics of the disclosure will be revealed by the detailed description of some advantageous embodiments given below by way of example, with reference to the appended drawings, in which:

FIGS. 1a) to e): are cross-sections of a variant of a foamed profile comprising a plurality of closed cavities, in particular an insulator, according to the disclosure and showing the development of the base profile over the course of the various steps of the method.

FIG. 2: is a cross-section of a structure using a foamed profile comprising a plurality of closed cavities, in particular an insulator according to the disclosure.

### DETAILED DESCRIPTION

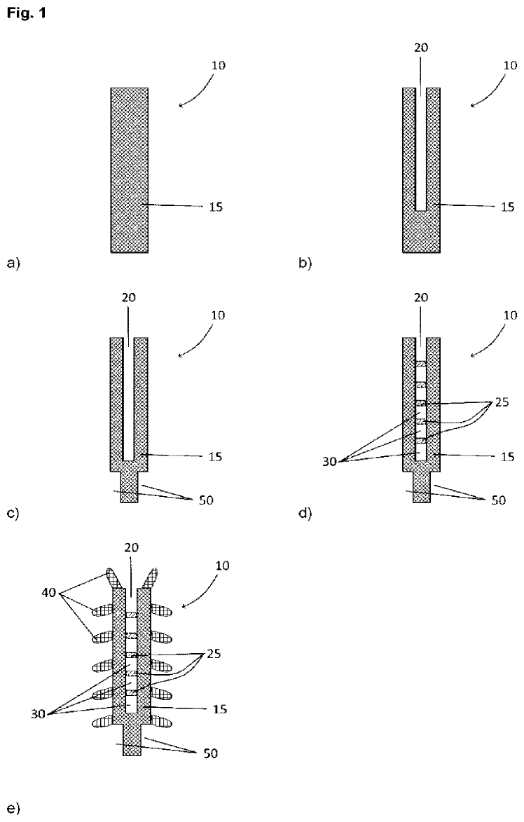

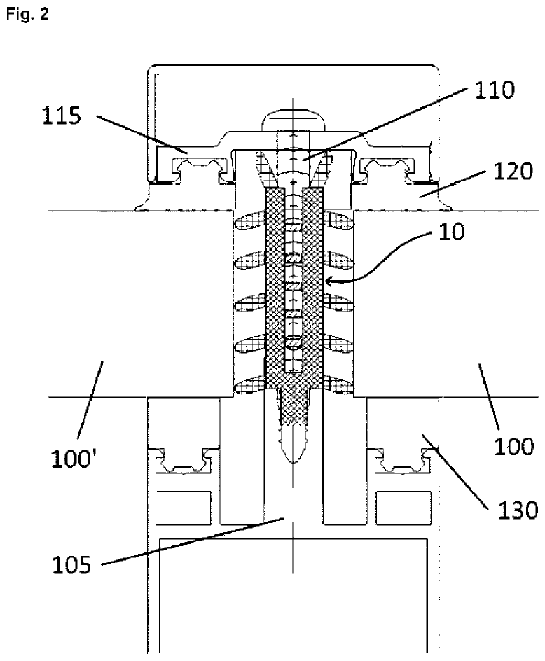

FIGS. 1a) to e) schematically illustrate the development of the base profile over the course of the various steps of the method to obtain the foamed profile comprising one or more longitudinal cavities of closed section. In FIGS. 1a) to e), reference numeral 10 denotes the profile at the respective stage it has reached. FIG. 1a) shows a base profile as may be obtained at the end of step (b), for example a base profile 15 of rectangular section. During step (c) (FIG. 1b)), a channel 20 is machined into the base profile 15. The depth of this cavity 20 will depend on the requirements of the intended application. In general, the channel will have a depth P representing 30 to 90% of the corresponding dimension of the base profile 15. Step (c′), which may be performed at the same time as step (c), removes a part of each side of the base profile at the opposite end to (the opening of) the channel 20 (FIG. 1c)) so as to form a head which may be inserted, for example, into the groove of a profile 105 as shown in FIG. 2. One important step of the present disclosure is step (d) of forming one or more cross struts 25 in the interior of the channel 20 and parallel to the bottom thereof located at a depth P (FIG. 1d)). As illustrated in FIG. 1e) and FIG. 2, it may be advantageous to add fins 40 during a step (x) in order to improve the insulation performance of a foamed profile according to the disclosure in certain applications. Step (x) may be performed at the same time as step (a) or after step (b), in particular before, during or after step (d); the order of FIGS. 1a) to e) is illustrative and therefore does not impose a single possible order in which the steps of the method have to be carried out.

FIG. 2 shows a section through an example structure using a foamed profile comprising a plurality of closed cavities, in particular an insulator 10 according to the disclosure, comprising (see FIG. 1e)) a base profile 15 with a channel 20 in which a plurality of cavities 30 have been formed by insertion of cross struts 25, the channel with the cross struts being crossed in places by fastening screws 110. The view shows the arrangement comprising a support profile 105 with lower gaskets 130 on which the glazing or panels 100, 100′ are placed. The insulator is introduced so as to fasten the head thereof into a groove of the support profile 105 between the panels or glazing 100, 100′. A fastening screw 110 crosses the insulator 10 and connects a façade profile 115 (which may be equipped with a cover) and upper gaskets 120 to the support profile 105. In the case illustrated in FIG. 2, the ends of the fins 40 are preferably located at a distance of between 0 and 2 mm from the structural elements, such as the glazing or panels 100, 100′ and therefore likewise compartment this space in order to reduce convective losses.

1. A method for manufacturing a foamed profile comprising one or more longitudinal cavities of closed section, the method comprising the steps of
(a) extruding a first polymer composition in the presence of one or more first foaming agents to yield a foamed base profile of polygonal section, the first polymer composition comprising one or more (co)polyesters,
(b) cooling the foamed base profile,
(c) creating a channel along the length of the foamed base profile by removing material, the channel forming two parallel branches in the foamed base profile, each of the branches comprising an outer surface facing away from the channel and an inner surface facing towards the channel, and
(d) extruding inside the channel a second polymer composition, which may or may not be identical to the first polymer composition, to yield a cross strut at at least one location between the two inner surfaces of the two branches of the channel, so as to form at least one closed cavity within the channel.

2. The method according to claim 1, further comprising, after step (b), a step (c′) of creating an external contour element on at least one of the sides of the foamed base profile by removing material.

3. The method according to claim 1, further comprising a step (x) of extruding a third polymer composition, to yield a number of fins on one or more sides of the base profile, wherein step (x) may be carried out during step (a) by coextrusion or by separate extrusion after one of the subsequent steps, before, during or after step (d).

4. The method according to claim 1, in which the first polymer composition comprises at least one (co)polyester selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, optionally blended with one or more (co)polymers selected from thermoplastic elastomers, including thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers or ethylene-butyl acrylate copolymers, modified or unmodified by groups including maleic anhydride or alternatively glycidyl methacrylate to compatibilize them with the (co)polyester(s), poly carbonate, polystyrene or polyamide.

5. The method according to claim 4, in which the content of (co)polyester(s) in the first polymer composition is greater than 60% by weight.

6. The method according to claim 1, in which the second polymer composition comprises at least one (co)polymer selected from thermoplastic elastomers, comprising thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers, ethylene-butyl acrylate copolymers, modified or unmodified to compatibilize them, polycarbonate, polystyrene, polyamide or (co)poly esters selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, or blends thereof, and thermoplastic elastomers and ethylene copolymers, grafted with maleic anhydride.

7. The method according to claim 3, in which the third polymer composition comprises at least one polymer selected from thermoplastic elastomers, comprising thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers, ethylene-butyl acrylate copolymers, modified or unmodified by groups including maleic anhydride or alternatively glycidyl methacrylate to compatibilize them, polycarbonate, polystyrene, polyamide, or (co)polyesters selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, or blends thereof.

8. The method according to claim 2, in which the first, second and/or third foaming agent(s) is/are independently selected from isobutane, cyclopentane and/or carbon dioxide.

9. The method according to claim 3, in which the first, second and/or third polymer compositions independently comprise other additives, comprising nucleating additives including talcum, calcium stearate or silica, chemical agents which accelerate the decomposition of the chemical foaming agents including zinc oxide and/or zinc stearate, fire-retardant agents, UV-stabilizers, antioxidants, crystallization nucleating agents, branching agents and/or lubricants.

10. The method according to claim 1, wherein the foamed profile comprising one or more longitudinal cavities of closed section obtained at an end of the method is a thermal insulator for reducing thermal bridging between two connected structural elements, the method comprising a step (c′) in which the external contour element on one of the sides of the foamed base profile is an insulator head of narrower section than the foamed base profile arranged on the opposite side of the channel.

11. A foamed profile comprising one or more longitudinal cavities of closed section, the foamed profile comprising a foamed base profile of polygonal section, the first polymer composition comprising one or more polyesters, the foamed base profile comprising a channel formed by removing material, said channel being compartmented into one or more closed cavities, parallel to a length of the foamed base profile, by a number of cross struts, extruded from a second polymer composition.

12. The foamed profile according to claim 11, further comprising part of the external contour modified by removing material.

13. The foamed profile according to claim 11, further comprising part of the external contour modified by by (co)extrusion or adhesive bonding of a number of fins onto one or more sides of the base profile.

14. The foamed profile according to claim 11, in which the first polymer composition comprises at least one (co)polyester selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, and polyethylene terephthalate, optionally blended with one or more (co)polymers selected from thermoplastic elastomers, including thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers or ethylene-butyl acrylate copolymers, modified or unmodified by groups including maleic anhydride or alternatively glycidyl methacrylate to compatibilize them with the (co)polyester(s), poly carbonate, polystyrene or polyamide.

15. The foamed profile according to claim 14, in which the content of (co)polyester(s) in the first polymer composition is greater than 60% by weight.

16. The foamed profile according to claim 11, in which the second polymer composition comprises at least one polymer selected from thermoplastic elastomers, including thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers, ethylene-butyl acrylate copolymers, modified or unmodified by groups including maleic anhydride or alternatively glycidyl methacrylate to compatibilize them, polycarbonate, polystyrene, polyamide or (co)polyesters selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, or blends thereof, and thermoplastic elastomers and ethylene copolymers, grafted with maleic anhydride.

17. The foamed profile according to claim 11, in which the third polymer composition comprises at least one polymer selected from thermoplastic elastomers, including thermoplastic polyester elastomers, unvulcanized thermoplastic olefinic elastomers, thermoplastic urethane elastomers, thermoplastic styrenic elastomers, thermoplastic polyamide elastomers, ethylene copolymers, including ethylene-vinyl acetate copolymers, ethylene-methyl acrylate copolymers, ethylene-ethyl acrylate copolymers, ethylene-butyl acrylate copolymers, modified or unmodified by groups including maleic anhydride or alternatively glycidyl methacrylate to compatibilize them, polycarbonate, polystyrene, polyamide, or (co)polyesters selected from polyglycolide or poly(glycolic acid), poly(lactic acid), polycaprolactone, polyhydroxyalkanoate, polyethylene adipate, polybutylene succinate, polyethylene terephthalate, polybutylene terephthalate, polytrimethylene terephthalate, polyethylene naphthalate, or blends thereof.

18. The foamed profile according to claim 11, in which the first, second and/or third polymer compositions independently comprise other additives, including nucleating additives comprising talcum, calcium stearate or silica, chemical agents which accelerate the decomposition of the chemical foaming agents comprising zinc oxide and/or zinc stearate, fire-retardant agents, UV-stabilizers, antioxidants, crystallization nucleating agents, branching agents and/or lubricants.

19. The foamed profile according to claim 11, which is an insulator for reducing thermal bridging between two connected structural elements, the insulator comprising an external contour element on one of the sides of the foamed base profile which is an insulator head of narrower section than the foamed base profile and which is arranged on the opposite side of the channel.

20. The method according to claim 1, wherein step (d) of extruding the second polymer composition is done in the presence of one or more second foaming agents.

21. The method according to claim 3, wherein step (x) of extruding the third polymer composition is done in the presence of one or more third foaming agents.
